(19) United States
(12) Patent Application Publication
(10) Pub. No.: US 2006/0114352 A1
(43) Pub. Date: Jun. 1, 2006

(54) Picture output apparatus and picture output method

(75) Inventor: Ken Hirata, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/288,125

(22) Filed: Nov. 29, 2005

(30) Foreign Application Priority Data
Nov. 30, 2004 (JP) 2004-347313

(51) Int. Cl. H04N 9/68; H04N 5/50; G09G 5/00

(52) U.S. Cl. 348/569; 345/611

(57) ABSTRACT

A picture output apparatus comprising a generator unit configured to generate an on-screen signal having a plurality of gradations, an acquisition unit configured to acquire color information which corresponds to each of the gradations possessed by the on-screen signal generated by the generator unit, and a converter unit configured to apply a highlight converting process to the on-screen signal based on the color information which corresponds to each of the gradations acquired by the acquisition unit.

### CROSS-REFERENCE TO RELATED APPLICATIONS

This application is based upon and claims the benefit of priority from prior Japanese Patent Application No. 2004-347313, filed Nov. 30, 2004, the entire contents of which are incorporated herein by reference.

### BACKGROUND OF THE INVENTION

1. Field of the Invention

The present invention relates to a picture output apparatus and a picture output method for outputting a signal for on-screen display.

2. Description of the Related Art

As is well known, in an on-screen display (OSD) on a character by character basis, for example, there is provided a so-called highlight function of highlighting only a specific character in a screen by changing a color of the specific character. This highlight function can carry out highlight conversion for changing two colors between a color of a specific character itself and a background color of the character.

On the other hand, in recent years, in a television receiver apparatus or the like, a gray scale font is used to improve the apparent resolution. However, in the case where this gray scale font has been used, there is an inconvenience that highlight conversion relevant to an intermediate gradation cannot be carried out with a current highlight function.

In Jpn. Pat. Appln. KOKAI Publication No. 10-126710, there is disclosed a technique of using an externally rewritable look up-table to carry out a process for superimposing a main screen and a graphics screen on each other, thereby making it possible to change the contents of the superimposing process (such as overlay, mask, monochrome processing, or highlight) without any circuit change merely by rewriting the contents of the look-up table.

However, in this technique described in Jpn. Pat. Appln. KOKAI Publication No. 10-126710, the contents of the look-up table are rewritten. Thus, the contents of the superimposing process on the entire screen can be changed. However, unlike the highlight function, it is impossible to highlight only a specific character in a screen by changing a color of the specific character.

### BRIEF SUMMARY OF THE INVENTION

According to one aspect of the present invention, there is provided a picture output apparatus comprising: a generator unit configured to generate an on-screen signal having a plurality of gradations; an acquisition unit configured to acquire color information which corresponds to each of the gradations possessed by the on-screen signal generated by the generator unit; and a converter unit configured to apply a highlight converting process to the on-screen signal based on the color information which corresponds to each of the gradations acquired by the acquisition unit.

According to another aspect of the present invention, there is provided a picture output method comprising: a first step of generating an on-screen signal having a plurality of gradations; a second step of acquiring color information which corresponds to each of the gradations possessed by the on-screen signal based on input color information and gradation number; and a third step of applying a highlight converting process to the on-screen signal based on the color information which corresponds to each of the gradation acquired by the second step.

### BRIEF DESCRIPTION OF THE SEVERAL VIEWS OF THE DRAWING

FIG. 1 is a block diagram showing a first embodiment of the present invention, the block diagram being adopted to explain a television receiver apparatus;

FIG. 2 is a view adopted to explain an example of a gray scale font before highlight conversion, the font being displayed on the television receiver apparatus in the first embodiment;

FIG. 3 is a view adopted to explain an intermediate color generated by a highlight processor unit of the television receiver apparatus in the first embodiment;

FIG. 4 is a view adopted to explain an example of a gray scale font after highlight conversion, the font being displayed on the television receiver apparatus in the first embodiment;

FIG. 5 is a view adopted to explain an example of an intermediate color before and after highlight conversion, the intermediate color being generated by the highlight processor unit of the television receiver apparatus in the first embodiment;

FIG. 6 is a view adopted to explain another example of an intermediate color before and after highlight conversion, the intermediate color being generated by the highlight processor unit of the television receiver apparatus in the first embodiment;

FIG. 7 is a flow chart adopted to explain a processing operation of the highlight processor unit of the television receiver apparatus in the first embodiment;

FIG. 8 is a block diagram showing a second embodiment of the present invention, the block diagram being adopted to explain a television receiver device;

FIG. 9 is a block diagram showing a third embodiment of the present invention, the block diagram being adopted to explain a television receiver device;

FIG. 10 is a view adopted to explain in detail a CLUT unit of the television receiver apparatus in the third embodiment; and

FIG. 11 is a block diagram showing a fourth embodiment of the present invention, the block diagram being adopted to explain a television receiver apparatus.

### DETAILED DESCRIPTION OF THE INVENTION

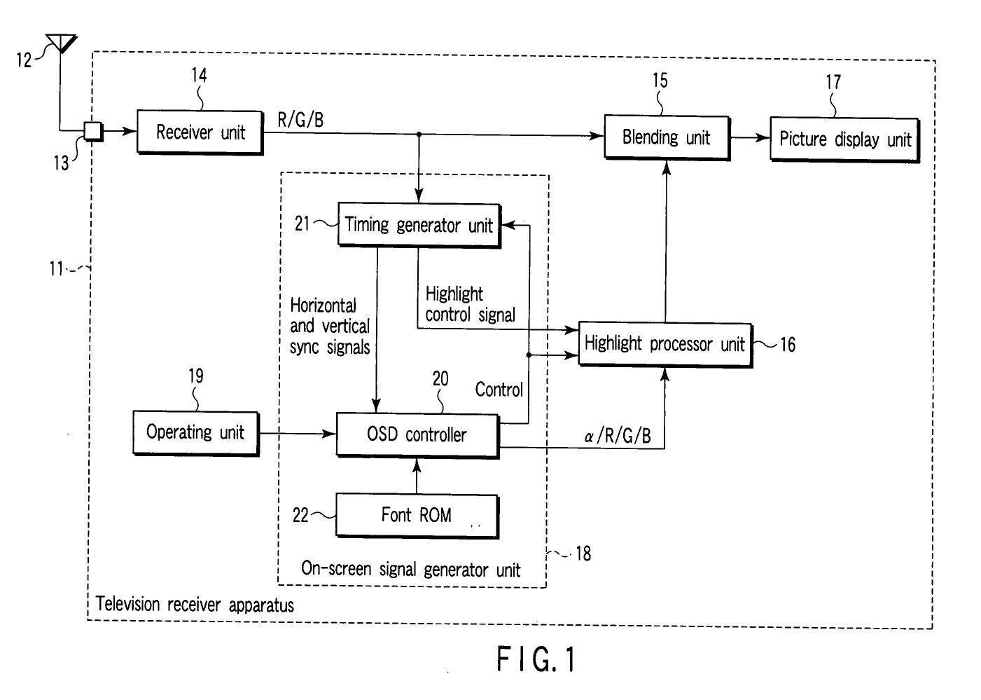

Hereinafter, a first embodiment of the present invention will be described in detail with reference to the accompanying drawings. FIG. 1 shows a television receiver apparatus 1 explained in the first embodiment. That is, in FIG. 1, reference numeral 12 denotes an antenna. A television broadcast signal received by this antenna 12 is supplied to a receiver unit 14 via an input terminal 13.

This receiver unit 14 generates R, G, and B signals by applying a predetermined decoding process to the input television broadcast signal. For example, in the case of Japan, the receiver unit 14 applies a channel selecting process, a demodulating process, an national television system committee (NTSC) decoding process or the like to the television broadcast signal.

Then, each of the R, G, and B signals generated by the receiver unit 14 is supplied to a blending unit 15. The blending unit 15 superimposes an on-screen signal output from a highlight processor unit 16 with respect to each of the input R, G, and B signals and supplies the superimposed signals to a picture display unit 17 which consists of a cathode ray tube (CRT) or the like and displays the supplied signal as a picture.

Here, the on-screen signal is generated by an on-screen signal generator unit 18. In the on-screen signal generator unit 18, an OSD controller 20 generates an on-screen signal based on operational information supplied from an operating unit 19 which includes a remote controller or the like, for example.

That is, the OSD controller 20 reads out an on-screen signal from a font read only memory (ROM) 22, and outputs the read-out signal to the highlight processor unit 16 in accordance with a command from the operating unit 19 and a display timing based on horizontal and vertical sync signals generated by a timing generator unit 21 based on the RGB signals output from the receiver unit 14.

The on-screen signal includes a font having a plurality of gradations, like a gray scale font, for example, and is composed of a blend value α used by the blending unit 15 and each of the R, G, and B signals. The blend value α may be stored in a font ROM 22 or may be generated by the OSD controller 20.

In addition, the OSD controller 20 generates and outputs a control signal for setting ON/OFF of a highlight function; a color before and after highlight conversion (two colors, color 1 and color 2); or a gradation number of a gray scale or the like, with respect to the highlight processor unit 16 based on a command from the operating unit 19.

Further, the timing generator unit 21 generates and outputs a highlight control signal indicating a timing to highlight with respect to the highlight processor unit 16 based on each of the R, G, and B signals output from the receiver unit 14.

Then, the highlight processor unit 16 computes each intermediate color before and after highlight conversion, in the case where highlight conversion has been made with respect to a gray scale font based on colors (two colors, color 1 and color 2) before and after highlight conversion and a gradation number of a grayscale, the colors and the gradation number having been input via the operating unit 19.

Computational formulas of intermediate colors, in the case where the gradation number of the gray scale is “m”, are shown below.
Intermediate color 1=color 1±[|color 1−color 2|×1/(m−1)]
Intermediate color 2=color 1±[|color 1−color 2|×2/(m−1)]
Intermediate color (m−2)=Intermediate color 1=color 1+[|color 1−color 2|×(m−2)/(m−1)]
(note that − is assigned in the case where color 1≧color 2, and + is assigned in the case where color 1<color 2)

The highlight processor unit 16 computes and holds a respective one of the R, G, and B signals of an intermediate color according to a full gradation of the gray scale before and after highlight conversion, in accordance with these computational formulas.

Then, in the case where an active highlight control signal is supplied from the timing generator unit 21, the highlight processor unit 16 determines whether or not an input on-screen signal coincides with a color before highlight conversion, based on the computation result and the setting of the OSD controller 20. In the case where the determination result is negative, the highlight processor unit 16 outputs the on-screen signal as is. In the case where the determination result is affirmative, the processor unit 16 converts the signal to data after conversion, and outputs the converted data.

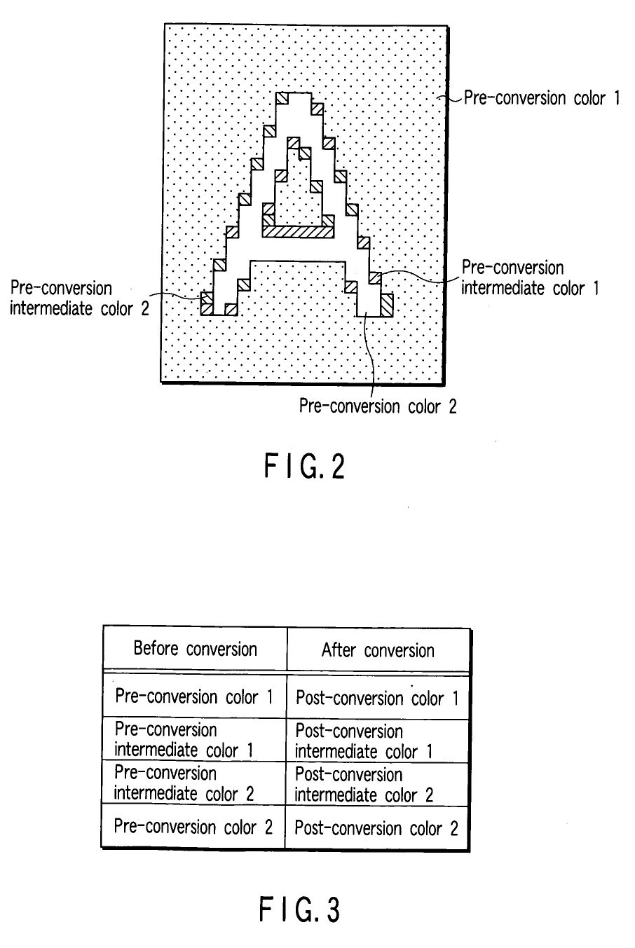

FIG. 2 shows a font before highlight conversion, in the case where the gradation number of the gray scale is 4. In this case, in the figure, a pre-conversion color 1 indicated by fine dotted line corresponds to black; and a pre-conversion color 2 indicated by a whitened portion corresponds to white. In the figure, a pre-conversion intermediate color 1 indicated by a right upward hatching and a pre-conversion intermediate color 2 indicated by the right downward hatching correspond to intermediate colors obtained by dividing the gradation into three equal sections from black to white.

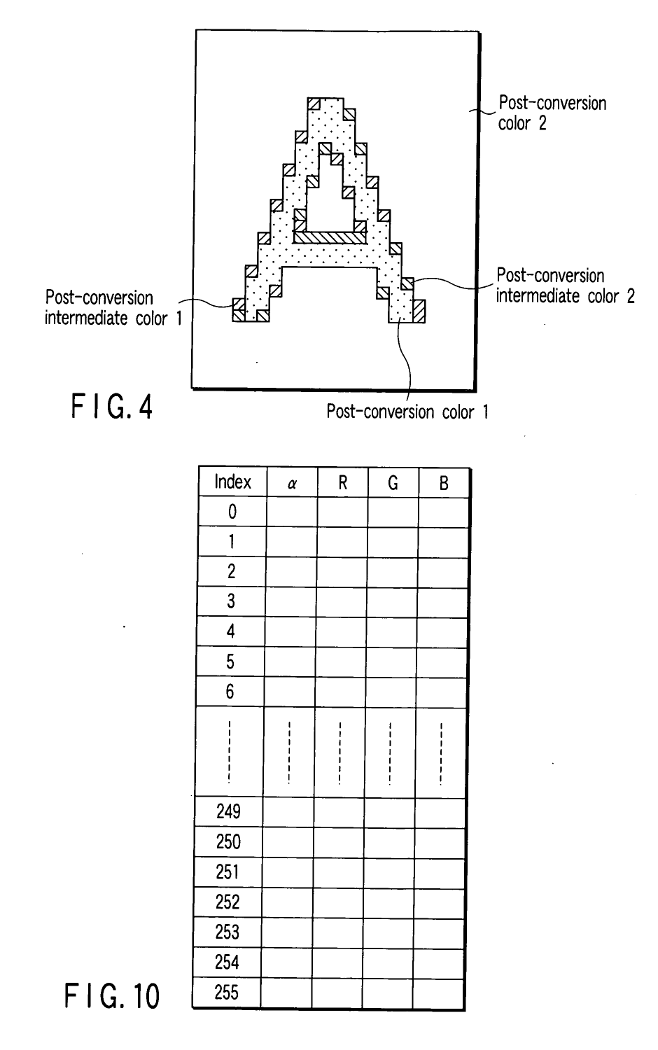

Here, information on the pre-conversion colors 1 and 2 and post-conversion colors 1 and 2 (black and white) and the gradation number (4) of the gray scale are input from the operating unit 19, whereby the highlight processor unit 16 generates pre-conversion intermediate colors 1 and 2 before highlight conversion and post-conversion intermediate colors 1 and 2 after highlight conversion, as shown in FIG. 3. In this manner, a gray scale font after highlight conversion as shown in FIG. 4 can be obtained.

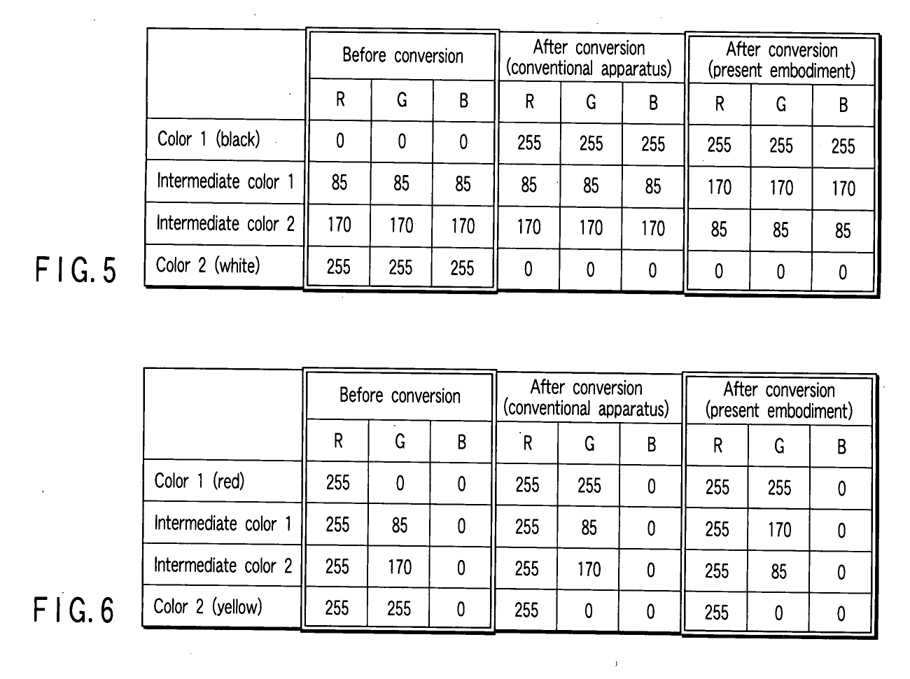

FIG. 5 shows values of the R, G, and B colors in the case where highlight conversion for inverting black and white has been made in a four-step gray scale font, as shown in FIGS. 2 and 4. In the conventional values after conversion, only the colors 1 and 2 are inverted. On the contrary, in the values after conversion according to the embodiment, it is found that the intermediate values 1 and 2 are inverted as well.

FIG. 6 shows values of the R, G, and B colors in the case where highlight conversion for inverting red and yellow has been made in a four-step gray scale font. In the conventional values after conversion, only the colors 1 and 2 are inverted. On the contrary, in the values after conversion according to the present embodiment, it is found that the intermediate values 1 and 2 are inverted as well.

FIGS. 5 and 6 each show an example of inverting the colors 1 and 2 before highlight conversion. However, even when different colors are used before and after highlight conversion, computation of an intermediate color can be carried out smoothly without any problem.

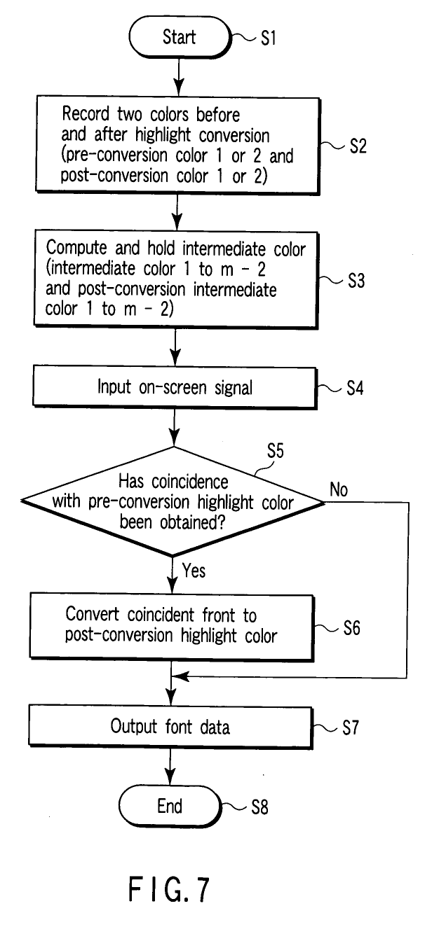

FIG. 7 shows a flow chart illustrating a processing operation of the above described highlight processor unit 16. That is, when processing is started (in step S1), the highlight processor unit 16 records two colors, namely, pre-conversion color 1 or 2 and post-conversion color 1 or 2, respectively, before and after highlight conversion, the two colors having been input by a user, in step S2.

Then, in step S3, the highlight processor unit 16 computes required pre-conversion color intermediate colors 1 to (m−2) from the pre-conversion colors 1 and 2 and the gradation number “m” of the gray scale and computes required post-conversion intermediate colors 1 to (m−2) from the post-conversion colors 1 and 2 and the gradation number “m” of the gray scale; and then, holds these computation results.

Then, in step S4, the highlight processor unit 16 inputs an on-screen signal output from the OSD controller 20. In step S5, the highlight processor unit 16 determines whether or not the input on-screen signal coincides with the highlight pre-conversion color [pre-conversion colors 1 and 2 and pre-conversion intermediate colors 1 to (m−2)] in units of pixels, for example.

In the case where the determination result is negative (NO), the highlight processor unit 16 outputs the font data as is on the input on-screen signal to the blending unit 15, in step S7, and terminates processing (in step S8).

In the case where it has been determined that font data on the on-screen signal input in the step S5 coincides with the highlight pre-conversion color (YES), the highlight processor 16 converts the font data to the highlight post-conversion color [post-conversion color 1 and 2 and post-conversion intermediate colors 1 to (m−2)] in step S6; outputs the converted color to the blending unit 15 in step S7; and terminates processing (in step S8).

Here, the blending unit 15 blends each of the R, G, and B signals which is an output of the receiver unit 14 and the on-screen signal output from the highlight processor unit 16 with each other. Although an example of this blending method is shown below, the blending method, of course, is not limited to this example. That is, an output of the blending unit 15 is as follows:
Each of R, G, and B signals×(1−α)+on-screen signal×α(note that 0≦α≦1)

According to the first embodiment, by inputting the two pre-conversion colors 1 and 2 and two post-conversion colors 1 and 2 before and after highlight conversion and the gradation number “m” of the gray scale, the highlight processor unit 16 computes and holds the required pre-conversion intermediate colors 1 to (m−2) and post-conversion intermediate colors 1 to (m−2), and then, converts the colors to the highlight post-conversion colors to be output to the gray scale font which correspond to the highlight pre-conversion colors. Therefore, it is possible to easily achieve a highlight function which corresponds to the gray scale font.

The intermediate colors are computed by the OSD controller 20 without being computed by the highlight processor 16, so that it is possible to notify the highlight processor unit 16 of the result and hold the notified result.

In FIG. 1, although an on-screen signal is stored in the font ROM 22, the signal may be stored in a random access memory (RAM) instead of the ROM. Further, the OSD controller 20 may generates a font by way of computation without using the ROM or RAM.

Further, while the foregoing first embodiment has described a construction having an antenna 12 and a receiver unit 14 because the embodiment is directed to a television receiver apparatus 11, the present invention is not limited to the television receiver apparatus 11. That is, instead of the antenna 12 or the receiver unit 14, for example, the present invention can be widely applied to equipment for outputting a picture signal such as a digital versatile disk (DVD) reproducing unit or an hard disk drive (HDD).

By operation of the operating unit 19, it is possible to provide settings which cause the highlight processor unit 16 not to carry out highlight conversion. In this case, the highlight processor unit 16 operates so as to output the input on-screen signal as is to the blending unit 15.

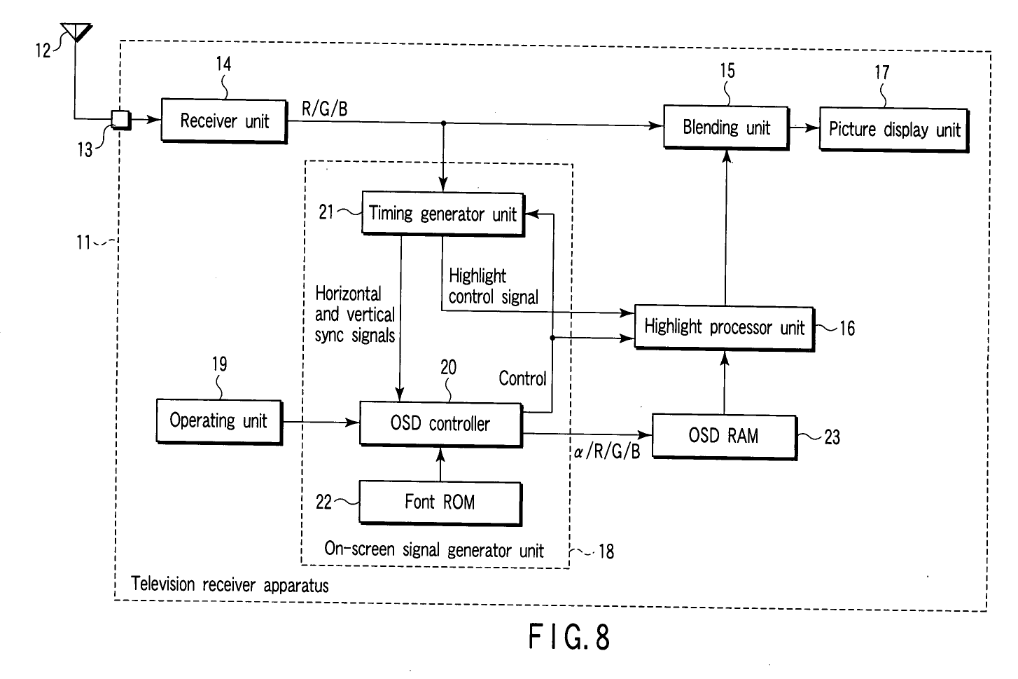

FIG. 8 shows a second embodiment of the present invention. In FIG. 8, like constituent elements in FIG. 1 are designated by like reference numerals. Referring to FIG. 8, the OSD controller 20 outputs an on-screen signal to an OSD RAM 23, and creates an on-screen display image. Then, the highlight processor unit 16 operates so as to sequentially reads out fonts from the OSD RAM 23, and configure an on-screen display (raster processing).

In this way, by using the OSD RAM 23, it becomes possible to create a screen more slowly than a data speed requested by the picture display unit 17. Thus, the use of the OSD RAM 23 is effective in the case where a processing speed of the OSD controller 20 is low or at the time of creating a complicated on-screen display.

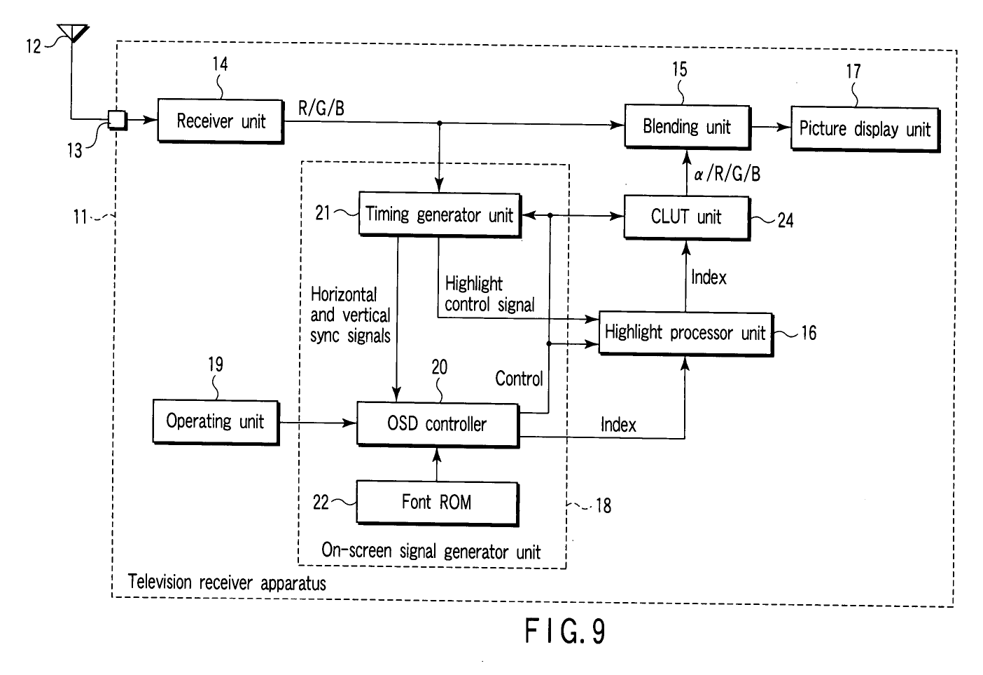

FIG. 9 shows a third embodiment of the present invention. In FIG. 9, like constituent elements in FIG. 1 are designated by like reference numerals. Referring to FIG. 9, a color look-up table (CLUT) unit 24 is interposed between the highlight processor unit 16 and the blending unit 15. Generally, the CLUT unit 24 is composed of a RAM, and a color look up table as shown in FIG. 10 is used.

In this case, the OSD controller 20 generates an Index signal which corresponds to an on-screen signal. The Index signal is produced as an address of the CLUT unit 24. Then, in this third embodiment, the highlight processor unit 16 carries out highlight conversion for converting an Index signal to another Index signal.

The highlight processor unit 16 also reads out the corresponding color information from the CLUT unit 24 based on the gradation number and input Index signal of the gray scale instructed from the OSD controller 20. A method of computing an intermediate color from the read out color information is identical to that according to the first embodiment. The computation result and the Index signal with which each data portion of α, R, G, or B of the CLUT unit 24 coincides are stored, respectively. At the time of highlight conversion, in the case where an input Index signal coincides with an Index signal before highlighted, the input Index signal is converted to an Index signal after highlighted. In the case where the signal does not coincide, the input Index signal is output as is.

The CLUT unit 24 outputs the corresponding blend value α and each of the R, G, and B signals while the Index signal supplied from the highlight processor unit 16 is produced as an address.

The Index signal is composed of fewer bits than a total bit number of each of the R, G, and B signals. For example, assuming that the Index signal is 8 bits, and the blend value a and each of the R, G, and B signals are 8 bits, respectively, the bit number of the Index signal becomes smaller by 24 bits with respect to 32 bits of color data including the blend value α.

At the same time, although the displayable color number is limited to index 8 bits=256 colors, this is sufficient as an on-screen. Thus, a circuit scale can be reduced without any problem.

In addition, the CLUT unit 24 is interposed, whereby the OSD controller 20 and the highlight processor unit 16 carry out processing of an Index signal. In this case, 8-bit processing will suffice, thus making it possible to reduce a circuit scale.

There is a need for the highlight processor unit 16 to carry out processing by way of an Index signal, and thus, the OSD controller 20 notifies the highlight processor unit 16 of the Index signal of a color to be highlighted. In the case where the highlight processor unit 16 carries out computation of an intermediate color or in the case where the OSD controller 20 does, an access is provided to the CLUT unit 24 based on the Index signal notified by the OSD controller 20, and computation is carried out after acquiring a color signal value.

While the present embodiment has described that the blend value α and each of the R, G, and B signals are 8 bits, the present invention, of course, is not limited thereto.

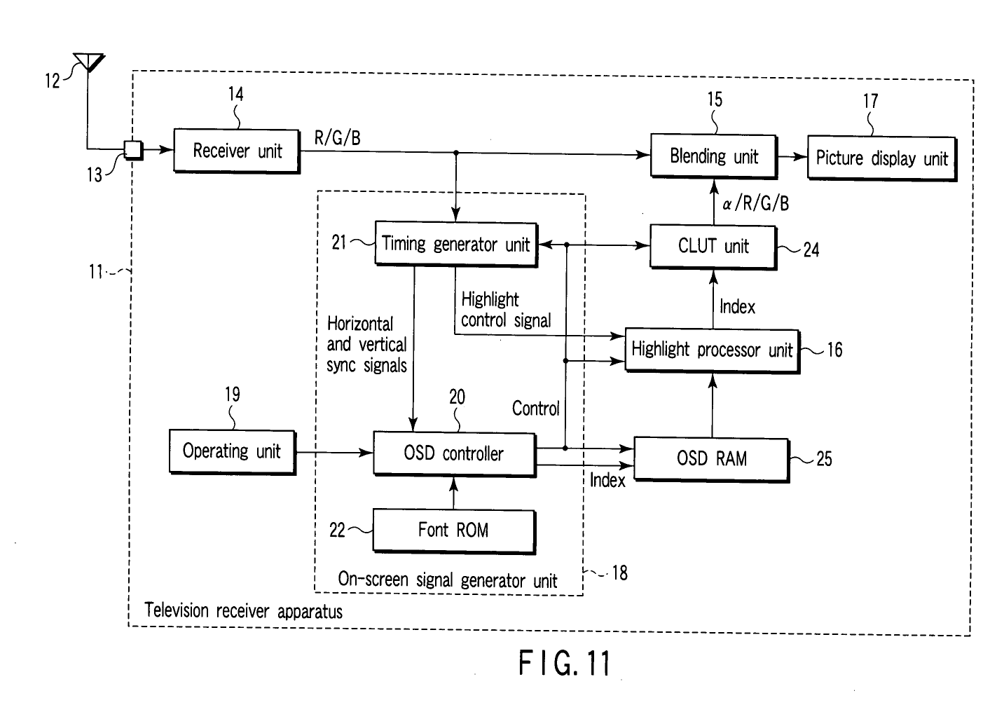

FIG. 11 shows a fourth embodiment of the present invention. In FIG. 11, like constituent elements in FIG. 9 are designated by like reference numerals. Referring to FIG. 11, the OSD controller 20 outputs an Index signal to an OSD RAM 25 and creates an on-screen display image. In order to create the on-screen display image by way of the Index signal, the OSD RAM 25 can be composed of fewer bits than that of each of the R, G, and B signals.

According to this fourth embodiment, as in the second embodiment, it becomes possible to create a screen more slowly than a data speed requested by the picture display unit 17 by using the OSD RAM 25. Thus, the use of the RAM is effective in the case where a processing speed of the OSD controller 20 is low or at the time of creating a complicated on-screen display.

The present invention is not limited to the embodiments. At a stage of carrying out the invention, the present invention can be applied to a graphics process or the like of a personal computer (PC), for example, and constituent elements can be embodied by variously modifying them without departing from the spirit of the invention.

In addition, a variety of inventions can be formed by properly combining a plurality of constituent elements disclosed in the above describe embodiments. For example, some of all the constituent elements disclosed in the embodiments may be eliminated. Further, the constituent elements according to the different embodiments may be properly combined with each other.

What is claimed is:

1. A picture output apparatus comprising:
a generator unit configured to generate an on-screen signal having a plurality of gradations;
an acquisition unit configured to acquire color information which corresponds to each of the gradations possessed by the on-screen signal generated by the generator unit; and
a converter unit configured to apply a highlight converting process to the on-screen signal based on the color information which corresponds to each of the gradations acquired by the acquisition unit.

2. A picture output apparatus according to claim 1, wherein
the acquisition unit is configured to acquire two types of pre-conversion color information before highlight conversion and pre-conversion intermediate color information which corresponds to an intermediate gradation thereof; and
the acquisition unit is configured to acquire two types of post-conversion color information after highlight conversion and post-conversion intermediate color information which corresponds to an intermediate gradation thereof.

3. A picture output apparatus according to claim 2, wherein
the converter unit is configured to determine font data having the pre-conversion color information and pre-conversion intermediate color information which coincide with each other from the on-screen signal; and
the converter unit is configured to apply a highlight converting process based on the post-conversion color information and post-conversion intermediate color information with respect to the determined font data.

4. A picture output apparatus according to claim 1, wherein,
when two types of input color information are defined as color 1 and color 2, and a gradation number of the on-screen signal is defined as “m”, the acquisition unit is configured to generate an intermediate color in accordance with a computation below:
Intermediate color 1=color 1±[|color 1−color 2|×1/(m−1)]
Intermediate color 2=color 1±[|color 1−color 2|×2/(m−1)]
Intermediate color (m−2)=color 1±[|color 1−color 2|×(m−2)/(m−1)]
(note that − is assigned in the case where color 1≧color 2 and + is assigned in the case where color 1<color 2)

5. A picture output apparatus according to claim 1, further comprising:
a storage unit configured to store the on-screen signal generated by the generator unit in order to create an on-screen display image, wherein
the converter unit is configured to apply a highlight converting process after sequentially reading out the on-screen signals from the storage unit.

6. A picture output apparatus according to claim 1, wherein
the generator unit is configured to output an index signal which corresponds to the on-screen signal;
the acquisition unit is configured to output an index signal according to color information which corresponds to each of the gradations possessed by the on-screen signal; and
the converter unit comprises a color look-up table for acquiring color information based on the index signal acquired from the generator unit and the acquisition unit.

7. A picture output apparatus according to claim 1, further comprising:
a receiver unit configured to receive a picture signal;
a blending unit configured to blend and output the picture signal received by the receiver unit and the on-screen signal to which a highlight converting process has been applied by the converter unit.

8. A picture output apparatus according to claim 7, wherein
the generator unit is configured to generate a blend value indicating a blending rate in the blending unit.

9. A picture output method comprising:
a first step of generating an on-screen signal having a plurality of gradations;
a second step of acquiring color information which corresponds to each of the gradations possessed by the on-screen signal based on input color information and gradation number; and
a third step of applying a highlight converting process to the on-screen signal based on the color information which corresponds to each of the gradation acquired by the second step.

10. A picture output method according to claim 9, further comprising:
a fourth step of receiving a picture signal; and
a fifth step of blending and outputting the picture signal received in accordance with the fourth step and the on-screen signal to which a highlight converting process has been applied in accordance with the third step.
